(19) United States
(12) Patent Application Publication
(10) Pub. No.: US 2006/0223938 A1
(43) Pub. Date: Oct. 5, 2006

(54) Pressure-sensitive adhesive for polarizing plates, polarizing plate having pressure-sensitive adhesive and production process for the polarizing plate

(75) Inventors: Koichi Nagamoto, Saitama (JP); Takayuki Arai, Tokyo (JP); Eiko Kozukue, Saitama (JP); Kazuhiro Kon, Saitama (JP); Tadashi Matano, Chiba (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: LINTEC CORPORATION, Itabashi-ku (JP)

(21) Appl. No.: 11/368,385

(22) Filed: Mar. 7, 2006

(30) Foreign Application Priority Data
Mar. 30, 2005 (JP) 2005-098685
Aug. 25, 2005 (JP) 2005-244881

(51) Int. Cl. C08L 33/00

(52) U.S. Cl. 524/556; 525/329.7; 525/342

(57) ABSTRACT

There are disclosed a pressure-sensitive adhesive for polarizing plates which is formed by irradiating a pressure-sensitive adhesive material with an active energy beam, the material containing an acrylic copolymer (A) and an acrylic copolymer bearing an active energy beam-polymerizable group on a side chain (B), and which has a storage elastic modulus (G′) at 23 ° C. in the range of 0.3 to 10 MPa: a polarizing plate which is having a pressure-sensitive adhesive, and which comprises a layer composed of the above pressure-sensitive adhesive; and a process for the production of the polarizing plate having a pressure-sensitive adhesive, which comprises sticking a polarizing plate on a pressure-sensitive adhesive material layer formed on a releasing layer of a releasing sheet, and thereafter irradiating the polarizing plate with an active energy-beam from the releasing sheet side. The pressure-sensitive adhesive for polarizing plates is characterized in that it can favorably sticking a polarizing plate to a liquid crystal cell and that a resultant liquid crystal display unit is less liable to cause light leakage even in an environment of high temperature and high humidity.

### BACKGROUND OF THE INVENTION

1. Field of the Invention

The present invention relates to a pressure-sensitive adhesive for polarizing plates, a polarizing plate having a pressure-sensitive adhesive and a process for the production of the polarizing plate. More particularly, the present invention pertains to a pressure-sensitive adhesive for polarizing plates which is applied to polarizing plates, particularly to a polarizing plate integrated with a visual field angle-expansion film or the like, and which is characterized in that it is capable of sticking with high durability, the polarizing plate to a liquid crystal cell and a liquid crystal display unit to be obtained therefrom is less liable to cause light leakage even in an environment of high temperature and high humidity; to a polarizing plate having the pressure-sensitive adhesive; and to a process for producing the polarizing plate.

2. Description of the Related Arts

There have heretofore been frequently caused such unfavorable situations that in the case of sticking a sheet composed of an organic material on an adherend such as glass, ceramics or a metal via a pressure-sensitive adhesive, the sheet peels off at an end and/or brings about lifting or relief accompanying the lapse of time.

In order to solve the above-mentioned unfavorable situations, there is generally employed a strongly pressure-sensitive adhesive material which is enhanced in pressure-sensitive adhesive performance by increasing the molecular weight of the components constituting the pressure-sensitive adhesive or enhancing crosslinking density. However, the use of the strongly a pressure-sensitive adhesive material, although enhances the holding power, makes the pressure-sensitive adhesive incapable of following the sheet under high temperature and high humidity conditions owing to shrinkage and swelling of the sheet composed of an organic material, thereby contributing to the occurrence of various troubles.

In this connection, some of optical parts are used by sticking a polarizing plate on a surface thereof, and are typically exemplified by a liquid crystal cell of a liquid crystal display unit (LCD).

Liquid crystal cell generally has such a structure that two transparent electrode substrates each forming an orientation layer are arranged so that the substrates are spaced at prescribed intervals with the orientation layers being located in the interior side using spacer, the perimeters of the substrates are sealed, a liquid crystal material is put at the above-mentioned intervals and polarizing plates are each placed on the two transparent electrode substrates via a pressure-sensitive adhesive.

The above-mentioned polarizing plate generally comprises polarization films having three layer constitution in which optical isotropic films, for instance, triacetyl cellulose (TAC) films are stuck on both the sides of polyvinyl alcohol based polarizer. The polarizing plate is further equipped on one side with a pressure-sensitive adhesive layer for the purpose of sticking on an optical part such as a liquid crystal cell.

In the case where the polarizing plate of the foregoing constitution is stuck on an optical part such as a liquid crystal cell, the resultant multi-structure of different materials brings about poor dimensional stability in terms of material properties, and particularly in an environment of high temperature and high humidity, gives rise to large dimensional variation due to shrinkage and swelling. Since the above-stated strongly pressure-sensitive adhesive material is generally used as the pressure-sensitive adhesive in the polarizing plate, it is possible to suppress lifting and peeling off which accompany dimensional variation of the polarizing plate, however it is impossible to absorb, in a pressure-sensitive adhesive layer, the stress accompanying the dimensional variation of the polarizing plate, whereby the residual stress in the polarizing plate is made non-uniform. Consequently, problems are raised in that a TN cell and an STN cell are liable to appear so-called light leakage and color unevenness, respectively.

In order to solve the above-described problems, there is disclosed technology of imparting stress relaxation properties by adding, for instance, a low molecular weight body such as a plasticizer to the pressure-sensitive adhesive so as to moderately soften the same (for instance, refer to Japanese Patent Publication No. 3272921). Nevertheless, the addition of a low molecular weight body is responsible for adherend pollution in the case of peeling off the polarizing plate, besides leads to lowered holding power, and is more liable to give rise to lifting and peeling off that are due to the lapse of time.

On the other hand, there is disclosed a pressure-sensitive adhesive sheet which is formed by radiation-crosslinking a composition containing an acrylic copolymer (A) and an acrylic copolymer bearing a radiation-polymerizable group on a side chain (B) at a ratio by weight of 100:1 to 100:100 (for instance, refer to Japanese Patent Application Laid-Open No. 107005/2001 (Heisei 13)).

Although the Patent Literature describes a working example for a polarizing plate, any of the working examples indicates a storage elastic modulus at 23° C. of less than 0.3 MPa, and besides fails to describe the size of the sample to be evaluated regarding light leakage property.

In addition, an evaluation was made of the light leakage property of the pressure-sensitive adhesive described in the working example of the Patent Literature, using a 15 inch polarizing plate by the present inventors. The result was not satisfactory.

Such being the case, it has been difficult to reconcile adhesion durability and light leakage preventability in a pressure-sensitive adhesive for polarizing plates, whereby the reconciliation between the two has been the major subject.

### SUMMARY OF THE INVENTION

It is an object of the present invention to provide under such circumstances, a pressure-sensitive adhesive for polarizing plates which is applied to polarizing plates, particularly to a polarizing plate integrated with a visual field angle-expansion film, and which is characterized in that it is capable of sticking with high durability, the polarizing plate on a liquid crystal cell and in that a liquid crystal display unit to be obtained is less liable to cause light leakage even in an environment of high temperature and high humidity; and a polarizing plate having the pressure-sensitive adhesive.

Other objects of the present invention will become obvious from the text of the specification hereinafter disclosed.

In order to achieve the above-mentioned objects, intensive extensive research and investigation were accumulated by the present inventors. As a result it has been discovered that the objects can be achieved by a pressure-sensitive adhesive which is formed by irradiating a pressure-sensitive adhesive material with an active energy beam, said material containing an acrylic copolymer and an acrylic copolymer bearing an active energy beam-polymerizable group on a side chain, and which has a specific storage elastic modulus (G′), and also that the above-described polarizing plate having a pressure-sensitive adhesive can be produced in high efficiency by sticking the polarizing plate on a pressure-sensitive adhesive material layer formed on a releasing layer of a releasing sheet, and conducting active energy beam irradiation from the side of the releasing sheet.

The present invention has been accomplished by the foregoing findings and information. That is to say, the present invention provides the following.
1. A pressure-sensitive adhesive for polarizing plates which is formed by irradiating a pressure-sensitive adhesive material with an active energy beam, said material comprising an acrylic copolymer (A) and an acrylic copolymer bearing an active energy beam-polymerizable group on a side chain (B); and which has a storage elastic modulus (G′) at 23° C. in the range of 0.3 to 10 MPa.
2. The pressure-sensitive adhesive for polarizing plates according to item 1, which has a storage elastic modulus (G′) at 80° C. in the range of 0.1 to 5 MPa.
3. The pressure-sensitive adhesive for polarizing plates according to item 1 or 2, wherein the acrylic copolymer bearing an active energy beam-polymerizable group on a side chain (B) comprises a monomer unit bearing-an active energy beam-polymerizable group in a proportion of 4 to 30% by mass.
4. The pressure-sensitive adhesive for polarizing plates according to any of items 1 to 3, wherein the pressure-sensitive adhesive material comprises an active energy beam-polymerizable group in a proportion of 5.0×10¹⁹ to 5.0×10²⁰ numbers per one gram of the material.
5. The pressure-sensitive adhesive for polarizing plates according to any of items 1 to 4, wherein the pressure-sensitive adhesive material further comprises a crosslinking agent (C) comprising at least one isocyanate based crosslinking agent.
6. The pressure-sensitive adhesive for polarizing plates according to any of items 1 to 5, wherein the pressure-sensitive adhesive material further comprises a silane coupling agent (D).
7. A polarizing plate having a pressure-sensitive adhesive, comprising a layer composed of the pressure-sensitive adhesive for polarizing plates according to any of items 1 to 6, and which has an adhesive strength for alkali free glass of at least 1 N/25 mm.
8. The polarizing plate having a pressure-sensitive adhesive according to item 7, wherein a polarizing film and a visual angle expansion film are integrated with each other.
9. A process for the production of the polarizing plate having a pressure-sensitive adhesive according to item 7 or 8, which comprises sticking a polarizing plate on a pressure-sensitive adhesive material layer formed on a releasing layer of a releasing sheet, and thereafter irradiating the polarizing plate with an active energy beam from the releasing sheet side.
10. A process for the production of an optical film, which comprises sticking a polarizing plate and a phase difference plate to each other by the use of the pressure-sensitive adhesive according to any of items 1 to 6.

### BRIEF DESCRIPTION OF THE DRAWING

FIG. 1 is an explanatory drawing showing a method for evaluating light leakage properties of the polarizing plate having the pressure-sensitive adhesive obtained in working examples and comparative examples.

### DESCRIPTION OF THE PREFERRED EMBODIMENTS

The pressure-sensitive adhesive for polarizing plates according to the present invention is a pressure-sensitive adhesive which is formed by irradiating a pressure-sensitive adhesive material with an active energy beam, said material comprising an acrylic copolymer (A) and an acrylic copolymer bearing an active energy beam-polymerizable group on a side chain (B).

The acrylic copolymer as the component (A) is exemplified by (meth)acrylic ester based copolymer. The (meth)acrylic ester as stated herein means both acrylic ester and methacrylic ester. Other similar terminologies shall be construed in the same manner.

As the (meth)acrylic ester based copolymer as mentioned above, there is used said copolymer having a crosslinking point which enables crosslinkage by means of any of various crosslinking methods. The (meth)acrylic ester based copolymer having a crosslinking point is not specifically limited, but may be properly optionally selected for use from the (meth)acrylic ester based copolymer which has hitherto been customarily employed as resinous component of a pressure-sensitive adhesive.

The (meth)acrylic ester based copolymer having such a crosslinking point is preferably exemplified by a copolymer of a (meth)acrylic ester wherein an alkyl group of ester moiety has 1 to 20 carbon atoms, a monomer having a crosslinkable functional group in the molecule, and an other monomer to be used as desired. Examples of a (meth)acrylic ester wherein an alkyl group of ester moiety has 1 to 20 carbon atoms include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, isooctyl (meth)acrylate, decyl (meth)acrylate, dodecyl (meth)acrylate, myristyl (meth)acrylate, palmityl (meth)acrylate and stearyl (meth)acrylate. Any of the above-cited (meth)acrylic esters may be used alone or in combination with at least one other species.

On the other hand, the monomer bearing a crosslinkable functional group in the molecule preferably bears at least one of hydroxyl group, carboxyl group, amino group and amide group, and is specifically exemplified by (meth)acrylic hydroxyl alkyl esters such as 2-hydroxyethyl (meth)acrylate, 2-hydroxypropyl (meth)acrylate, 3-hydroxypropyl (meth)acrylate, 2-hydroxybutyl (meth)acrylate, 3-hydoxybutyl (meth)acrylate and 4-hydoxybutyl (meth)acrylate; acrylamides such as acrylamide, methacrylamide, N-methylacrylamide, N-methylmethacrylamide, N-methylolacrylamide and N-methylolmethacrylamide; monoalkyl aminoalkyl (meth)acrylate such as monomethyl aminoethyl (meth)acrylate, monoethyl aminopropyl (meth)acrylate, monomethyl aminopropyl (meth)acrylate and monoethyl aminopropyl (meth)acrylate; and ethylenically unsaturated carboxylic acids such as acrylic acid, methacrylic acid, crotonic acid, maleic acid, itaconic acid and citraconic acid. Any of the monomers may be used alone or in combination with at least one other species.

The polymerization type of the (meth)acrylic ester based copolymer to be used as the component (A) is not specifically limited, but may be any of random, block and graft polymerization. There is preferably usable the copolymer having a weight average molecular weight of at least 1,000,000. When the weight average molecular weight thereof is at least 1,000,000, the adhesiveness to an adherend, adhesion durability and the like are made sufficient without causing lifting or peeling off. Taking adhesiveness and adhesion durability into consideration, the weight average molecular weight thereof is preferably at least 1,200,000, particularly preferably in the range of 1,200,000 to 2,000,000. The molecular weight distribution (Mw/Mn) which represents the ratio of the weight average molecular weight (Mw) to the number average molecular weight (Mn) in the (meth)acrylic ester based copolymer is preferably at most 20. When the molecular weight distribution is at most 20, the proportion of low molecular weight components is lessened, thereby assuring sufficient adhesion durability even in a working environment such as a high temperature. On the other hand, the lower limit of the molecular weight distribution is not specifically limited from the aspect of the performance, but is preferably at least 2 taking the manufacturing cost into consideration.

The above-mentioned weight average molecular weight (Mw) is measured by gel permeation chromatography (GPC) and expressed in terms of polystyrene.

In the (meth)acrylic ester based copolymer, the content of the monomer moiety bearing a crosslinkable functional group in the molecule is preferably in the range of 0.01 to 10% by mass. When the content thereof is at least 0.01% by mass, sufficient crosslinking and favorable durability are assured by the reaction with a crosslinking agent as will be described hereinafter. On the other hand, when the content thereof is at most 10% by mass, a decrease in sticking adaptabilities on liquid crystal glass cells which is caused by excessively high degree of crosslinking is preferably obviated. Taking into consideration the durability, sticking adaptabilities to liquid crystal glass cells and the like factors, the content of the monomer moiety bearing a crosslinkable functional group is in the range of preferably 0.05 to 7.0% by mass, particularly preferably 0.2 to 6.0% by mass. The (meth)acrylic ester based copolymer as the component (A) may be used alone or in combination with at least one other species.

In the above-mentioned pressure-sensitive adhesive material, the (meth)acrylic ester based copolymer bearing an active energy beam-polymerizable group on a side chain to be used as the component (B) is obtainable for instance, by utilizing the crosslinkable functional group in the (meth)acrylic ester based copolymer which group is obtained in the same manner as in the case of the acrylic ester based copolymer as the component (A). That is to say, it needs only to react a crosslinkable functional group of the (meth)acrylic ester copolymer with the functional group (hereinafter referred to as “reactive group”) of a compound bearing an active energy beam-polymerizable group and a reactive group which reacts with the crosslinkable functional group in its molecule. The active energy beam-polymerizable group is exemplified by (meth)acryloyloxy group and the like. The reactive group is properly optionally selected according to the type of the crosslinkable functional group, and is exemplified for instance, by isocyanate group and epoxy group in the case where the crosslinkable functional group is carboxyl group, by isocyanate group in the case where the crosslinkable functional group is hydroxyl group, by isocyanate group in the case where the crosslinkable functional group is amino group or substituted amino group, by carboxyl group in the case where the crosslinkable functional group is epoxy group. As a specific instance, in the case where the crosslinkable functional group of the (meth)acrylic ester based copolymer is carboxyl group or hydroxyl group, it needs only to subject isocyanate group as a reactive group and (meth)acryloyloxyisocyanate bearing (meth)acryloyloxy group as a polymerizable group to addition reaction. Examples of the (meth)acryloyloxyisocyanate include acryloyloxyethylisocyanate, acryloyloxypropylisocyanate, methacryloyloxyethylisocyanate and methacryloyloxypropylisocyanate. The reaction needs only to be conducted by an ordinary method usually at a temperature in the range of 25 to 60° C. for 6 to 48 hours. A catalyst may be used according to the demand such as an organo-tin compound including dibutyltin dilaurate and a substituted amine compound.

It is preferable in the present invention that the content of the monomer moiety bearing the active energy beam-polymerizable group in the acrylic based copolymer bearing active energy beam-polymerizable group in a side chain is in the range of 3 to 30% by mass. When the content thereof is within the foregoing range, the storage elastic modulus at 2° C. and 80° C. can be made to be a desired value after irradiating the pressure-sensitive adhesive material with an active energy beam, and favorable results are obtained in stability of the storage of the acrylic based copolymer as the component (B) and coating adaptability of the pressure-sensitive adhesive to be obtained. The content thereof is more preferably 4 to 30% by mass.

The weight average molecular weight of the acrylic based copolymer as the component (B) is preferably at least 400,000, more preferably in the range of 500,000 to 2,000,000. Even if the acrylic based copolymer as the component (B) has a low molecular weight as compared with the above-mentioned component (A), the crosslinking is advanced by the active energy beam irradiation because of its bearing active energy beam-polymerizable group in a side chain with the result that the pressure-sensitive adhesive to be obtained is enhanced in adhesion durability under the conditions of high temperature and humid heat.

In the present invention, the acrylic ester based copolymer as the component (B) may be used alone or in combination with at least one other species.

In order that the pressure-sensitive adhesive to be obtained may have desirable storage elastic modulus at 23° C. and 80° C., the active energy beam-polymerizable group is contained in a proportion of preferably 5.0×10¹⁹ to 5.0×10²⁰ numbers, more preferably 1.0×10²⁰ to 3.0×10²⁰ numbers in 1 g of the pressure sensitive adhesive material.

The content ratio of the acrylic ester based copolymer bearing active energy beam-polymerizable group in a side chain as the component (B) to the acrylic ester based copolymer as the component (A), although depending upon the number of the active energy beam-polymerizable groups, is in the range of preferably 5 to 1000 parts by mass of (B) based on 100 parts by mass of the component (A), more preferably 30 to 300 parts by mass.

In the above-mentioned pressure-sensitive adhesive material, a multi-functional acrylate based monomer and an active energy beam-curable acrylic oligomer may be used as desired, in combination with the acrylic ester based copolymer bearing active energy beam-polymerizable group in a side chain as the component (B) to the extent that any of the objects of the present invention is not impaired thereby.

It is possible as desired to allow the above-mentioned pressure-sensitive adhesive material to contain a photopolymerization initiator, which is exemplified, for instance, by benzoin; benzoin methyl ether; benzoin ethyl ether; benzoin isopropyl ether; benzoin-n-butyl ether; benzoin isobutyl ether; acetophenone; dimethylaminoacetophenone; 2,2-dimethoxy-2-phenylacetophenone; 2,2-diethoxy-2-phenylacetophenone; 2-hydroxyl-2-methyl-1-phenylpropane-1-one; 1-hydroxycyclohexyl phenylketone 2-methyl-1-[4-(methylthio) phenyl]-2-morpholyno-propane-1-one; 4-(2-hydroxyethoxy)phenyl-2-(hydroxyl-2-propyl) ketone; benzophenone; p-phenylbenzophenone; 4,4′-diethylaminobenzophenone; dichlorobenzophenone; 2-methyl anthraquinone; 2-ethyl anthraquinone; 2-tertiallybutyl anthraquinone; 2-amino anthraquinone; 2-methyl thioxanthone; 2-ethyl thioxanthone; 2-chloro thioxanthone; 2,4-dimethyl thioxanthone; 2,4-diethyl thioxanthone; benzyl methyl ketal; acetophenone dimethyl ketal; p-dimethylamino benzoic ester; oligo[2-hydroxyl-2-methyl-1[4-(1-methylvinyl)phenyl]propane; and 2, 4, 6-trimethylbenzoyl-diphenyl-phosphine oxide. The above-enumerated species may be used alone or in combination with at least one other species. The blending amount is usually selected in the range of 0.2 to 20 parts by mass based on 100 parts by mass of the component (B).

It is possible as desired to allow the pressure-sensitive adhesive material to contain a crosslinking agent as the component (C), which is not specifically limited, but may be properly optionally selected for use from among the crosslinking agents that have heretofore been customarily employed for acrylic based pressure-sensitive adhesive. Examples of the crosslinking agents include polyisocyanate compounds, epoxy resin, melamine resin, urea resin, dialdehydes, methylol polymer, aziridine based compounds, metallic chelate compounds, metal alkoxide and metallic salts. In the present invention, it is preferable to use a crosslinking agent containing at least a polyisocyanate compound that is an isocyanate based crosslinking agent. Examples of the polyisocyanate compounds include aromatic polyisocyanate such as tolylenediisocyanate, diphenylmethanediisocyanate and xylylenediisocyanate; aliphatic polyisocyanate such as hexamethylenediisocyanate; and alicyclic polyisocyanate such as isophoronediisocyanate and hydrogenated diphenylmethanediisocyanate, their biuret bodies, isocyanurate bodies and adduct bodies that are the reaction products with a hydrogen-containing low molecular compounds such as ethylene glycol, propylene glycol, neopentyl glycol, trimethylol propane and castor oil.

In the present invention, the crosslinking agent may be used alone or in combination with at least one other species. The amount thereof to be used, which depends upon the type of the crosslinking agent, is in the range of usually 0.01 to 20 parts by mass, preferably 0.1 to 10 parts by mass based on 100 parts by mass of sum total of the components (A) and (B) in the above-mentioned pressure-sensitive adhesive material.

It is possible as desired to allow the pressure-sensitive adhesive material to contain a silane coupling agent as the component (D), whereby the adhesiveness between the pressure-sensitive adhesive and a glass cell is made more favorable in the case of sticking a polarizing plate, for instance, on a liquid crystal glass cell or the like. The silane coupling agent, which is an organosilicon compound bearing at least one alkoxysilyl group in the molecule, is preferably well compatible with a pressure-sensitive adhesive component, imparted with light transmittance, and substantially transparent. The amount thereof to be added is in the range of preferably 0.001 to 10 parts by mass, particularly preferably 0.005 to 5 parts by mass based on 100 parts by mass of the solid content of the pressure-sensitive adhesive material.

Specific examples of the above-mentioned silane coupling agents include polymerizable unsaturated group-containing silicon compounds such as vinyltrimethoxysilane, vinyltriethoxysilane and methacryloxypropyl-trimethoxysilane; silicon compounds having an epoxy structure such as 3-glycidoxypropyltrimethoxysilane and 2-(3,4-epoxycyclohexyl)ethyl-trimethoxysilane; amino group-containing silicon compounds such as 3-aminopropyltrime thoxysilane; N-(2-aminoethyl)-3-aminopropyl-trimethoxysilane; and N-(2-aminoethyl)-3-aminopropylmetyldimethoxy-silane; and 3-chloropropyltrimethoxysilane.

The silane coupling agent may be used alone or in combination with at least one other species.

The pressure-sensitive adhesive material may be incorporated as desired with any of well known additives that have heretofore been usually used in acrylic based pressure-sensitive adhesive to the extent that any of the objects of the present invention are not impaired thereby. The additives are exemplified, for instance, by tackifying agents, antioxidants, ultraviolet absorbers, light stabilizers, softening agents, fillers and the like.

The pressure-sensitive adhesive for polarizing plates according to the present invention is formed by irradiating the pressure-sensitive adhesive material obtained in the above-stated manner with an active energy beam.

The active energy beam is exemplified by ultraviolet ray and electron beam. The ultraviolet ray is obtained from a high-pressure mercury lamp, an electrodeless lamp, a xenon lamp and the like, on the other hand, electron beam is obtained from an electron beam accelerator or the like. Of the active energy beam, ultraviolet ray is particularly preferable. In the case of using electron beam, a pressure-sensitive adhesive can be formed without the use of the photopolymerization initiator.

The irradiation quantity for the pressure-sensitive adhesive material is properly optionally selected so as to obtain a crosslinked pressure-sensitive adhesive imparted with the storage elastic modulus and the adhesive strength for alkali free glass. It is preferable that in the case of ultraviolet ray, the illuminance is 50 to 1000 mW/cm² and light quantity is 50 to 1000 mJ/cm²., and in the case of electron beam, the absorbed dose is 10 to 1000 krad.

It is necessary that the pressure-sensitive adhesive for polarizing plates according to the present invention has a storage elastic modulus (G′) at 23° C. in the range 0.3 to 10 MPa. The storage elastic modulus at 23° C. thereof, when being at least 0.3 MPa, leads to sufficient light leakage preventability, and when being at most 10 MPa, forms a pressure-sensitive adhesive having favorable adhesion durability. In view of the foregoing, the storage elastic modulus (G′) at 23° C. thereof is preferably in the range of 0.5 to 5 MPa. Moreover the storage elastic modulus (G′) at 80° C. thereof is preferably in the range of 0.1 to 5 MPa.

The above-mentioned storage elastic modulus (G′) is measured by the method described hereunder.

<Method for Measuring Storage Elastic Modulus (G′)>

A pressure-sensitive adhesive is laminated to a thickness of 30 μm, and made into a columnar test piece measuring 8 mm in diameter by 3 mm in thickness, and the storage elastic modulus (G′) is measured by torsional shear method under the following conditions.

Measuring instrument: dynamic viscoelastic modulus measuring instrument (manufactured by Rheometric Corporation under the trade name” DYNAMIC ANALYZER RDA II)

Frequency: 1 Hz

Temperature: 23° C., 80° C.

The pressure-sensitive adhesive for polarizing plates according to the present invention can be applied to a polarizing plate composed only of a polarization film, and used for sticking the polarizing plate, for instance, to a liquid crystal glass cell, while in particular, it can be preferably applied to a polarizing plate in which a polarization film and a visual field angle-expansion film are integrated with each other, and used for sticking the polarizing plate, for instance, on a liquid crystal glass cell.

The polarizing plate in which a polarization film and a visual field angle-expansion film are integrated with each other is exemplified, for instance, by a polarization film which is composed of a polyvinyl alcohol based polarizer and a triacetyl cellulose (TAC) film stuck on both the sides of the polarizer, and further composed of a visual field angle-expanding function layer comprising a discotic liquid crystal which is formed by coating on one side of the polarization film, and the polarization film same as the foregoing except that the visual field angle-expansion function film is stuck with an adhesive. In these cases, the pressure-sensitive adhesive is formed on the side of the above-mentioned visual field angle-expansion function layer or visual field angle-expansion film.

A liquid crystal display unit which is produced by sticking the polarizing plate to the liquid crystal glass cell or the phase difference plate in the above-mentioned manner by the use of the pressure-sensitive adhesive for polarizing plates according to the present invention is less liable to light leakage even in an environment of high temperature and high humidity and besides is excellent in adhesion durability between the polarizing plate and the liquid crystal glass cell.

Further in the case where a phase difference plate is put between the polarizing plate and the liquid crystal glass cell via a pressure-sensitive adhesive in order to contrive the improvement on visual field angle characteristics, the pressure-sensitive adhesive for polarizing plates according to the present invention is suitably usable. That is to say, the polarizing plate composed only of a polarization film and a phase difference plate are stuck with the pressure-sensitive adhesive according to the present invention to produce an optical film, and the phase difference plate of the resultant optical film and a liquid crystal glass cell are stuck on each other by means of a pressure-sensitive adhesive, which is not specifically limited, but may be selected for use from among the pressure-sensitive adhesives that are usually used for sticking a polarizing plate and a liquid crystal glass cell. Specific examples thereof include a pressure-sensitive adhesive material composed of an acrylic copolymer, a crosslinking agent and a silane coupling agent as disclosed in Japanese Patent Application Laid-Open No. 131033/1999 (Heisei 11). Moreover the pressure-sensitive adhesive according to the present invention is also usable for sticking the polarizing plate and the liquid crystal glass cell.

In addition, the present invention provides a polarizing plate which has the pressure-sensitive adhesive, which has a adhesive strength for alkali free glass being at least 1 N/25 mm, and which has a layer composed of the above-mentioned pressure-sensitive adhesive for polarizing plates according to the present invention.

The foregoing adhesive strength, when being at least 1 N/25 mm, makes it possible to stick a polarizing plate, for instance, on a liquid crystal glass cell with sufficient adhesive strength, and is more preferably in the range of 3 to 30 N/25 mm. A method for measuring the adhesive strength will be described in detail hereinafter.

As mentioned hereinbefore, the polarizing plate may be composed only of a polarization film, but the polarizing plate and visual field angle-expansion film are preferably integrated with each other.

The thickness of the layer composed of the above-mentioned adhesive for polarizing plates is in the range of usually about 5 to 100 μm, preferably 10 to 50 μm.

The process for the production of the polarizing plate having a pressure-sensitive adhesive is not specifically limited except that it needs only to be a method enabling to obtain a polarizing plate on which the layer composed of adhesive according to the present invention is formed. According to the process of the present invention as described hereunder, it is possible to produce desirable polarizing plate having a pressure-sensitive adhesive in high efficiency.

In the process thereof, a polarizing plate is stuck on a pressure-sensitive adhesive material layer which has been formed on a releasing layer of a releasing sheet, and thereafter the pressure-sensitive adhesive material is irradiated with an active energy beam from the side of releasing sheet so that the above-mentioned pressure-sensitive adhesive material layer becomes a layer constituted of the pressure-sensitive adhesive according to the present invention imparted with the prescribed characteristics, whereby the polarizing plate having a pressure-sensitive adhesive is obtained.

Examples of the releasing sheet include plastic film such as polyester film made of polyethylene terephthalate, polybutylene terephthalate polyethylene naphthalate or the like; polyolefin film such as polypropylene, polyethylene or the like, which plastic film is coated with a releasing agent such as silicone resin so as to form a releasing layer. The thickness of the releasing sheet is not specifically limited, but is usually about 20 to 150 μm.

The pressure-sensitive adhesive material and the irradiation conditions of an active energy beam are each same as those already described in foregoing pressure-sensitive adhesive for polarizing plates according to the present invention.

As a method for forming a pressure-sensitive adhesive material layer on a releasing sheet, there is usable a method wherein a pressure-sensitive adhesive material which is incorporated with a solvent is applied as coating to the releasing sheet by means of bar coat method, knife coat method, roll coat method, blade coat method, die coat method, gravure coat method or the like method to form a coat and then dry the coat. The drying condition is not specifically limited, but usually includes a temperature of 50 to 150° C. and a drying time of 10 seconds to 10 minutes, approximately. Examples of the solvent include toluene, xylene, ethyl acetate, butyl acetate, methyl ethyl ketone, methyl isobutyl ketone, methyl alcohol, ethyl alcohol and isopropyl alcohol. The concentration of the pressure-sensitive adhesive material is preferably 5 to 30% by mass.

The working effects and advantages of the present invention are summarized in the following. The pressure-sensitive adhesive for polarizing plates according to the present invention is preferably applied to polarizing plates, particularly to a polarizing plate integrated with a visual field angle-expansion film or the like. The invention is characterized in that it is capable of sticking with high durability, the polarizing plate to a liquid crystal cell and at in that a liquid crystal display unit to be obtained is less liable to cause light leakage even in an environment of high temperature and high humidity. It also provides the polarizing plate having the pressure-sensitive adhesive and a process for producing the polarizing plate.

In what follows, the present invention will be described in more detail with reference to comparative examples and working examples, which however shall never limit the present invention thereto.

The weight average molecular weight of the acrylic based copolymer, the performance of the pressure-sensitive adhesive and the performance of the polarizing plate having the pressure-sensitive adhesive which were obtained in each of the examples and comparative examples were determined by the procedures as described hereunder.

(1) Measurement of Weight Average Molecular Weight of the Acrylic Based Copolymer

The weight average molecular weight of an acrylic based copolymer expressed in terms of polystyrene was measured by gel permeation chromatography method (hereinafter abbreviated to “GPC method”). A calibration curve was prepared in advance using polystyrene. A solution of 1% by mass of an acrylic based copolymer in tetrahydrofuran (THF) was prepared, and a measurement was made of the weight average molecular weight thereof by using [GEL PERMEATION CHROMATOGRAPH HLC 8020] (triple acting column consisting of TSK_{GEL} GMH_{XL}, TSK_{GEL} GMH_{XL}, TSK_{GEL} G2000H_{XL}) manufactured by Tosoh Corporation under the conditions of 40° C., THF solvent and one milliliter/minute, in which use was made of a TSK GUARD COLUMN manufactured by Tosoh Corporation. The molecular weight distribution was expressed by the ratio of the weight average molecular weight Mw to the number average molecular weight Mn (Mw/Mn).

(2) Storage Elastic Modulus of Pressure-Sensitive Adhesive

Storage elastic modulus of pressure-sensitive adhesive at 23° C. and 80° C. was measured according to the method stated in the text of this specification.

(3) Adhesive Strength (Adhesive Strength for Alkali-Free Glass)

A sample measuring 25 mm in width and 100 mm in length was cut off from a polarizing plate having a pressure-sensitive adhesive, a releasing sheet was peeled off (thickness of the pressure-sensitive adhesive layer being 25 m), the sample was stuck on alkali free glass (manufactured by Corning Corporation under the trade name “1737”), then the sample was pressurized in an autoclave (manufactured by Kurihara Manufactory Inc.) under the conditions of 0.5 MPa, 50° C. and 20 minutes, thereafter it was allowed to stand in an environment of 23° C. and 50% RH (relative humidity) for 24 hours, and then the pressure-sensitive adhesive strength was measured under the conditions of peeling velocity being 300 mm/min and peeling angles being 180 degrees by the use of a tensile strength tester (manufactured by ORIENTEC Co., LTD under trade name “Tensilon”)

(4) Durability of Polarizing Plate Having a Pressure-Sensitive Adhesive

A polarizing plate having a pressure-sensitive adhesive was regulated to a rectangular size of 233 mm by 309 mm by the use of a cutting machine (manufactured by OGINO SEIKI CO., LTD. under the trade name “Super Cutter [PN 1-600] ”), then the sample of the polarizing plate was stuck on alkali free glass (manufactured by Corning Incorporated under the trade name “1737”), thereafter the sample was pressurized in an autoclave (manufactured by Kurihara Manufactory Inc.) under the conditions of 0.5 MPa, 50° C. and 20 minutes, then it was placed in an environment including each of the under-mentioned conditions of durability, and after the lapse of 200 hours observation was made by means of a magnifier (loupe) with 10 magnification to evaluate the durability on the basis of the following criterion.
◯: no defect at a distance of 0.6 mm or more perpendicularly from any of peripheral end in four sides
X: abnormality and/or defect of 0.1 mm or larger or longer in appearance of pressure-sensitive adhesive such as lifting, peeling off, foaming or streak being observed at a distance of 0.6 mm or more perpendicularly from peripheral end in any of four sides
   <Durable Conditions>

Conditions of 60° C. and RH of 90%, 80° C., 90° C., or −20° C. [symbol] 60° C. 200 cycles of heat shock test for 30 minutes each in an environmental

(5) Light Leakage Test

A polarizing plate having a pressure-sensitive adhesive was regulated to a rectangular size of 233 mm by 309 mm by the use of a cutting machine (manufactured by OGINO SEIKI Co., LTD under the trade name “Super Cutter [PN1-600] ”), then the sample of the polarizing plate was stuck on alkali free glass (manufactured by Corning Incoporated under the trade name “1737”) so that the polarization axis of the polarizing plate having a pressure-sensitive adhesive became cross nicol state on both the front and rear sides of the alkali free glass, thereafter the sample was pressurized in an autoclave (manufactured by Kurihara Manufactory Inc.) under the conditions of 0.5 MPa, 50° C. and 20 minutes, then it was allowed to stand in this state at 80° C. for 200 hours, thereafter allowed to stand in an environmental conditions of 23° C. and RH of 50% for 2 hours to evaluate the light leakage properties on the basis of the following criterion.

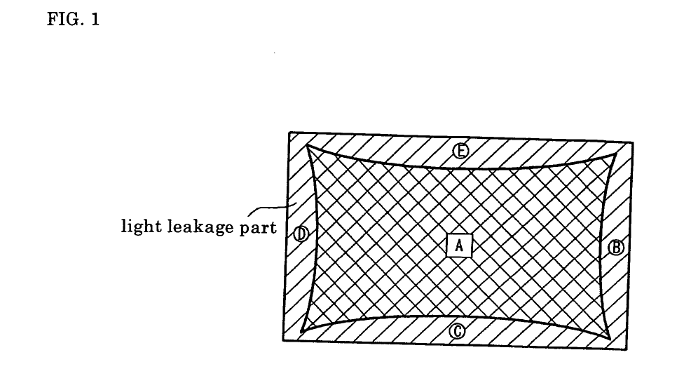

By the use of a measuring apparatus (manufactured by OTSUKA ELECTRNICS CO., LTD. under the trade name MCPD-2000), measurements were made of the illuminance for each region as illustrated in FIG. 1 and also of illuminance difference ΔL* from the following formula to determine light leakage properties.
ΔL*=[(b+c+d+e)/4]−a
where a, b, c, d and e each are illuminance at a preliminary prescribed measuring point in the regions A, B, C, D and E (one point in the central part in each of the regions). It means that light leakage decreases with a decrease in the value of ΔL*.

### EXAMPLES 1 to 3 & COMPARATIVE EXAMPLES 1 to 3

Pressure-sensitive adhesive materials having chemical compositions (solid content ratio) as given in Table 1 were prepared, and applied as coating onto the releasing layer of a polyethylene terephthalate-made releasing film (manufactured by LINTEC Corporation, Ltd. under the trade name “SP-PET 3811”) having 38 μm thickness as the releasing sheet with a knife type coating machine so as to obtain 25 μm thickness after drying. Thereafter, the materials thus coated were dry treated at 90° C. for one minute to form pressure-sensitive adhesive material layers.

Subsequently polarizing plates in which a polarization film and a visual field angle-expansion film were integrated with each other were composed each of the polarization film having discotic liquid crystal layer, were stuck so that the pressure-sensitive adhesive material layers each come into contact with the discotic liquid crystal layer. After the lapse of 30 minutes from the sticking, the pressure-sensitive adhesive material thus stuck were irradiated with ultraviolet (UV) ray from the side of releasing films under the following conditions to prepare polarizing plates each having the pressure-sensitive adhesive.

<Conditions of Irradiation with UV>

*An electrodeless lamp—H valve (manufactured by Fusion Co., Ltd.) was used.
Illuminance of 600 mW/cm², light quantity of 150 mJ/cm²
There were used a UV illuminance meter and an actinometer that were manufactured by EYEGRAPHICS CO, LTD. under the trade name “UVPF-36”.

Table 2 gives the evaluation results for the performances of the pressure-sensitive adhesives and the performances of the polarizing plates each having the pressure-sensitive adhesive.

TABLE 1

| | Chemical composition of pressure-sensitive adhesive material (parts by mass) | | | | | | |
|---|---|---|---|---|---|---|---|
| | acrylic | polymerizable | | isocyanate | | silane | **Number of |
| | based | acrylic/based | | based | | coupling | Active energy |
| | copolymer | copolymer (B)²⁾ | | crosslinking | Photopolymerization | agent | beam polypmerizable |
| | (A)¹⁾ | type | amount | agent (C)³⁾ | initiator⁴⁾ | (D)⁵⁾ | groups(×10²⁰⁾ |
| Example 1 | 100 | B1 | 250 | 1.5 | 0.5 | 0.2 | 1.32 |
| Example 2 | 100 | B1 | 200 | 1.5 | 0.5 | 0.2 | 1.23 |
| Example 3 | 100 | B3 | 35 | 0.75 | 1.5 | 0.2 | 2.04 |
| Comp. | 100 | — | 0 | 1.5 | 0 | 0.2 | 0 |
| Example 1 | | | | | | | |
| Comp. | 0 | B2 | 100 | 1.5 | 0.2 | 0.2 | 2.71 |
| Example 2 | | | | | | | |
| Comp. | 100 | B1 | 20 | 1.5 | 0.5 | 0.2 | 0.365 |
| Example 3 | | | | | | | |
| {Remarks} | | | | | | | |
| ¹⁾Acrylic copolymer (A): 95 parts by mass of butyl acrylate and 5 parts by mass of acrylic acid being polymerized by a conventional process, the copolymer having a weight average molecular weight of 1,500,000, a molecular weight distribution of 3.5, 18% by mass solution of ethyl acetate was used for preparing pressure-sensitive adhesive material | | | | | | | |
| ²⁾Acrylic copolymer (B) bearing active energy beam polymerizable group on a side chain (hereinafter abbreviated to “polymerizable acrylic copolymer (B)”) | | | | | | | |
| B1: contains 4.8% by mass of active energy beam polymerizable group-containing monomer unit, having a weight average molecular weight of 1,500,000, obtained by adding 5 parts by mass of methacryloyloxyethyl isocyanate (46 equivalent weight for carboxylic acid groups of acrylic acid unit) to 100 parts by mass of acrylic copolymer (A) obtained in the same manner as in the preceding item 1), and subjecting the resultant mixture to addition reaction at 25° C. for 24 hours. | | | | | | | |
| B2: contains 7.0% by mass of active energy beam polymerizable group-containing monomer unit, having a weight average molecular weight of 1,500,000, obtained by adding 7.5 parts by mass of methacryloyloxyethylisocyanate (70 equivalent weight to 100 equivalent weight of carboxylic acid groups of acrylic acid unit) to 100 parts by mass of acrylic based copolymer (A) obtained in the same manner as in the preceding item 1), and subjecting the resultant | | | | | | | |
| # mixture to addition reaction at 25° C. for 24 hours. To prepare pressure-sensitive adhesive material, there was used 15% by mass solution of each of B1 and B2 in ethyl acetate. | | | | | | | |
| B3: contains 20.6% by mass of active energy beam polymerizable group-containing monomer unit, having a weight average molecular weight of 600,000, obtained by adding 26 parts by mass of methacryloyloxyethylisocyanate (78 equivalent weight to 100 equivalent weight of hydroxyl groups of 2-hydroxyethyl acrylate unit), and further adding dibutyltin dilaulate as the catalyst in an amount of 0.01 part by mass based on 100 parts of the | | | | | | | |
| # acrylic based copolymer, to 100 parts by mass of an acrylic based copolymer which had a weight average molecular weight of 600,000, a molecular weight distribution of 8.0 and 30% by mass of solid concentration in the case of using a mixed solution of toluene and ethyl acetate, and which had been obtained by polymerizing 65 parts by mass of butyl acrylate, 10 parts by mass of methyl methacrylate and 25 parts by mass of 2-hydroxyethyl acrylate by a | | | | | | | |
| # conventional process, and subjecting the resultant mixture to addition reaction at 25° C. for 24 hours. | | | | | | | |

³⁾Isocyanate based crosslinking agent: trimethylolpropane-modified tolylenediisocyanate (manufactured by NIPPON POLYURETHNE INDUSTRY CO., LTD. under the trade name Colonate L)
⁴⁾Photopolymerization initiator: mixture of benzophenone and 1-hydroxyl cyclohexylphenyl ketone at a proportion by mass of 1:1 (manufactured by Chiba Specialty Chemicals Co., Ltd. under the trade name “Irgacure 500”)
⁵⁾Silane coupling agent: 3-glycidoxypropyltrimethoxysilane (manufactured by Shin-Etsu Chemical Industries Co., Ltd. under the trade name “KBM-403”)
**number of active energy beam polymerizable groups (×10²⁰) that are contained in one gram of pressure-sensitive adhesive material

TABLE 2

| | Performance of pressure- | | | | | | | |
|---|---|---|---|---|---|---|---|---|
| | sensitive adhesive | | | Performance of polarization plate having pressure- | | | | |
| | storage | | | sensitive adhesive | | | | |
| | elastic | | | Durability | | | | |
| | modulus | | Adhesive | 60° C. | | | | |
| | (MPa) | | strength | 90% | | | heat | Light leakage |
| | 23° C. | 80° C. | (N/25 mm) | RH | 80° C. | 90° C. | shock | performance (ΔL*) |
| Example 1 | 0.89 | 0.60 | 7.5 | ◯ | ◯ | ◯ | ◯ | 1.03 |
| Example 2 | 0.60 | 0.32 | 11.0 | ◯ | ◯ | ◯ | ◯ | 1.55 |
| Example 3 | 1.80 | 1.20 | 15.0 | ◯ | ◯ | ◯ | ◯ | 1.51 |
| Comp. | 0.11 | 0.08 | 18.5 | ◯ | ◯ | ◯ | ◯ | 8.30 |
| Example 1 | | | | | | | | |
| Comp. | 21.5 | 8.50 | 0.8 | X | ◯ | ◯ | X | 0.53 |
| Example 2 | | | | | | | | |
| Comp. | 0.13 | 0.09 | 18.0 | ◯ | ◯ | X | ◯ | 5.30 |
| Example 3 | | | | | | | | |

What is claimed:

1. A pressure-sensitive adhesive for polarizing plates which is formed by irradiating a pressure-sensitive adhesive material with an active energy beam, said material comprising an acrylic copolymer (A) and an acrylic copolymer bearing an active energy beam-polymerizable group on a side chain (B), and which has a storage elastic modulus (G′) at 23° C. in the range of 0.3 to 10 MPa.

2. The pressure-sensitive adhesive for polarizing plates according to claim 1, which has a storage elastic modulus (G′) at 80° C. in the range of 0.1 to 5 MPa.

3. The pressure-sensitive adhesive for polarizing plates according to claim 1 or 2, wherein the acrylic copolymer bearing an active energy beam-polymerizable group on a side chain (B) comprises a monomer unit bearing an active energy beam-polymerizable group in a proportion of 4 to 30% by mass.

4. The pressure-sensitive adhesive for polarizing plates according to any of claim 1 to 3, wherein the pressure-sensitive adhesive material comprises an active energy beam-polymerizable group in a proportion of 5.0×10¹⁹ to 5.0×10²⁰ numbers per one g of the material.

5. The pressure-sensitive adhesive for polarizing plates according to any of claim 1 to 4, wherein the pressure-sensitive adhesive material further comprises a crosslinking agent comprising at least an isocyanate based crosslinking agent (C).

6. The pressure-sensitive adhesive for polarizing plates according to any of claim 1 to 5, wherein the pressure-sensitive adhesive material further comprises a silane coupling agent (D).

7. A polarizing plate having a pressure-sensitive adhesive, comprising a layer composed of the pressure-sensitive adhesive for polarizing plates according to any of claim 1 to 6 and which has an adhesive strength for alkali free glass of at least 1 N/25 mm.

8. The polarizing plate having a pressure-sensitive adhesive according to claim 7, wherein a polarizing film and a visual angle expansion film are integrated with each other.

9. A process for the production of the polarizing plate having a pressure-sensitive adhesive according to claim 7 or 8, which comprises sticking a polarizing plate on a pressure-sensitive adhesive material layer formed on a releasing layer of a releasing sheet, and thereafter irradiating the polarizing plate with an active energy beam from the releasing sheet side.

10. A process for the production of an optical film, which comprises sticking a polarizing plate and a phase difference plate to each other by the use of the pressure-sensitive adhesive according to any of claim 1 to 6.
